(19) United States
(12) Patent Application Publication
(10) Pub. No.: US 2007/0150323 A1
(43) Pub. Date: Jun. 28, 2007

(54) Method and system for generating supply chain planning information

(76) Inventors: June-Ray Lin, Dali City (TW); Chi-Hung Huang, Taipei City (TW); Chun-Kai Wang, Shulin City (TW); Chia-Chun Shih, Banciao City (TW)

Correspondence Address: RABIN & Berdo, PC, 1101 14TH STREET, NW, SUITE 500, WASHINGTON, DC, 20005, US

(21) Appl. No.: 11/471,555

(22) Filed: Jun. 21, 2006

(30) Foreign Application Priority Data
Dec. 28, 2005 (TW) 094146991

(51) Int. Cl. G06F 17/50

(52) U.S. Cl. 705/7

(57) ABSTRACT

A method and a system for generating supply chain planning information are provided, which are used to dynamically adjust the control factors of the supply information provided by an original supplier and an original logistics provider, after the first supply chain planning information has been generated through a conventional supply chain planning information system, so as to generate much more supply information to process. Then, the information is processed by a planning engine of the supply chain planning information system to further generate other supply chain planning information among which to select in decision making. Hence, a decision maker can select and find out improved ways to negotiate with suppliers, so as to reduce the total cost and also meet customers' service quality requirements.

### CROSS-REFERENCE TO RELATED APPLICATIONS

This non-provisional application claims priority under 35 U.S.C. § 119(a) on patent application No(s). 094146991 filed in Taiwan, R.O.C. on Dec. 28, 2005, the entire contents of which are hereby incorporated by reference.

### BACKGROUND OF THE INVENTION

1. Field of Invention

The present invention relates to a method and a system for generating supply chain planning information, and more particularly to a method and a system for generating supply chain planning information which can be used for dynamically adjusting the control factors of supply information, so as to generate much more supply chain planning information among which to select in decision making.

2. Related Art

A supply chain can be defined as a cooperation strategy for integrating and coordinating operation procedures in cross-functional departments between enterprises, while supply chain management aims at promoting the efficiency of cooperation between enterprises and achieving competitive advantages in enterprise operation through preferably considering reductions in product lead time and operation cost. The best example of supply chain management is Electronic Data Interchange (EDI), applied to business affairs.

In the past, EDI was used as a management tool for the supply chain to achieve the objects of information communication and electronic interchange between enterprises, thereby increasing information transparency and reducing transaction cost, meanwhile avoiding wasting human resources used to input data repeatedly and reducing errors in the process of data operation. However, complete supply chain management not only contemplates purchase of raw materials and relationship with suppliers, but also covers raw materials, product delivery to customers, even subsequent after-sale service, and so on.

In other words, supply chain management is used to efficiently integrate supply, manufacture, storage, and other business flows, such that an enterprise is able to manufacture and distribute a proper number of products in a proper time period to proper sites, thereby reducing the total cost of products and also meeting customers' service quality requirements.

The short-term goal of supply chain management is to enhance production capacity, decrease stocks, reduce costs, and shorten the time required for a marketing cycle of products. The long-term goal is mainly directed at enhancing customer satisfaction, market share, and corporate profits.

At present, supply chain systems established with the aim of reasonably allocating and delivering materials and stocks have widely appeared in industries with the manufacturing industry as the main part. An important factor that influences the performance of the whole supply chain is the collection of purchase demand (or commodity consumption) of final customers and forecasting information. As for a relationship mainly based on a specific manufacturer, in an industry with purchasers as the market leader, the reasonable allocation and the desired lowest cost of the supply chain are affected, since the purchaser cooperates negatively and cannot provide sellers with necessary commodity consumption information appropriately, which is the most common factor resulting in failure of the supply chain system.

Generally, material types and items provided by a supply chain system developed by a specific supplier only occupy an extremely small part of the materials demanded by the purchaser. As a result, the purchaser who faces various suppliers must add a particular work flow internally in order to coordinate with the operation of one specific supply chain, which not only increases the administration cost, but also lacks of flexibility, thus resulting in a disadvantage of the conventional supply chain system.

On the other hand, compared with the supply chain system developed focusing on manufacturers and suppliers, the demand chain is established with a purchaser being regarded as the main body for enjoying services and emphasizes on effectively managing purchaser stocks, collecting purchasing orders of the purchaser, and forecasting future requirements, such that service quality with which a buyer is satisfied will be achieved with the lowest possible purchasing cost. Therefore, in an industry with purchasers as the leader part, it is much more important to establish and integrate the demand chains of purchasing operations for various purchasers in the same field than it is to establish the supply chain.

However, it is a stern challenge for the demand chain system to integrate the information of different operation systems for various purchasers. As for the current Group Purchasing Organization, since the information systems of various purchasers cannot be integrated in real time, both purchasing demand forecasting and data collection usually must be conducted manually. Furthermore, in the circumstance that other delivery terms haven't been obviously changed, the orders of various purchasers during a specific period are merely summed together when placing an order, such that the objects of reducing specific cost and developing new sources and opportunities are not achieved for the supplier, which is another existing disadvantage.

Therefore, in view of the above, through a well managed supply chain, products, clients, products lifetime cycles, and sites will be optimally arranged on the Global Transaction Network according to chronological sequence, thereby achieving maximum profits with minimum costs. Therefore, nowadays, various operation methods are being used to optimize supply chains between enterprises and various suppliers, so as to avoid the situations of excessive stocks and insufficient stocks on the competitive market due to uncoordinated supply and demand. Uncoordinated supply and demand often results in missed opportunities, profit loss, excessive delivery costs, loss of market share, insufficient customer service, and so on.

Therefore, at present, a number of techniques concerning supply chain optimization have been provided in various technologies. For example, a most-benefit combination, such as reduced material costs, delay costs, or carrying costs, is achieved directly between the data provided by customers and the schedules set up by factories through a constraint satisfaction mechanism, such as in U.S. Pat. Nos. 6,430,573, 5,353,229, and 6,546,302. Alternatively, a most-benefit combination can be achieved by dynamically adding, modifying, and deleting some restrictive rules, such as in U.S. Pat. Nos. 6,856,980, 6,031,984, 6,216,109, and 5,855,009.

Furthermore, such as that disclosed in U.S. Pat. No. 6,236,976, an optimal combination is achieved through a systematized method and then the result is corrected through a non-systematized method. In another technology, such as that disclosed in U.S. Pat. No. 6,260,024, a method and a mechanism are provided to integrate the requirements of a purchaser to look for a possible seller and solve possible conflicts. Alternatively, as disclosed in U.S. Pat. No. 6,889,197, a centralized server is set in a supply chain structure, and the information in the supply chain is integrated and shared on the server.

In all aforementioned conventional arts, a highly efficient combination is achieved by adding restrictive conditions or correcting the optimization results of the supply chain. However, these methods cannot be used to provide additional feasible directions or seek improved directions in the short term, which is an existing disadvantage.

### SUMMARY OF THE INVENTION

An object of the present invention is mainly to provide a method and a system for generating supply chain planning information, wherein various supply information provided by an original supplier and an original logistics provider are dynamically adjusted; various supply information are newly added according to the original supply information; and then more than one supply chain planning information is generated through a planning engine and provided to a decision maker for being selected, thereby generating a most-benefit combination.

In the method for generating supply chain planning information disclosed by the present invention, the target condition (TCᵢ=₁) set initially and the supply information collection (CMᵢ=₁) obtained outside are used to generate the first supply chain planning information (Sᵢ=₁) through the planning engine, wherein CMᵢ=₁ includes at least one control factor (C₁ⱼ), and C₁ⱼ includes at least one supply information (RFx_{1j,k}) containing a provider (R_{1j,k}), a quotation (Q_{1j,k}), and a weight (W_{1j,k}). Furthermore, in the method, C₁ⱼ and RFx_{1j,k} are dynamically adjusted to enable the planning engine to generate more than one Sᵢ₌₂ . . . Sᵢ₌ₙ. The method of the present invention is first to establish an information analysis rule and a numerical analysis rule.

Next, at least one C₁ⱼ is selected from CMᵢ₌₁ according to the information analysis rule, and then R_{1j,k} and Q_{1j,k} of RFx_{1j,k} in C₁ⱼ are changed into RFx_{ij,k,i=2} . . . RFx_{ij,k,i=n} according to the numerical analysis rule, and all or a part of RFx_{1j,k} is selected to generate CMᵢ₌₂ . . . CMᵢ₌ₙ according to W_{ij,k=1 . . . n}.

Subsequently, CMᵢ₌₂ . . . CMᵢ₌ₙ are sequentially combined with CMᵢ₌₁ to generate the corresponding Sᵢ₌₂ . . . Sᵢ₌ₙ through the planning engine; Sᵢ₌₂ . . . Sᵢ₌ₙ are sorted based on TCᵢ₌₁; and then at least one of RFx_{ij,k,i=2} . . . RFx_{ij,k,i=n} corresponding to Sᵢ₌₁ . . . Sᵢ₌ₙ is selected to generate new supply information (RFx_{ijw}).

Then, RFx_{ij,k} is updated according to RFx_{ij,w}, and the corresponding W_{ij,k=1 . . . n} of R_{ij,k,k=1} . . . R_{ij,k,k=n} corresponding to each of Sᵢ₌₁ . . . Sᵢ₌ₙ is adjusted according to the updated RFx_{ij,k}.

In comparison to the prior art, the present invention has the advantage that it provides information rules to analyze and adjust the original supply information, and thereby adds various supply information different from the original one, so as to generate more than one supply chain planning information. Furthermore, more than one supply chain planning information are provided to a decision maker for being selected to seek an improved direction to negotiate with a supplier, so as to reduce the overall cost and meanwhile meet customers' service quality requirements.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a flow chart of a method for generating supply chain planning information according to the present invention;

FIG. 2 is a block diagram of a system for generating supply chain planning information according to the present invention;

FIG. 3 is diagram according an embodiment of the present invention;

FIG. 4A is the supply information provided by a material supplier according to the embodiment of the present invention;

FIG. 4B is the supply information provided by a logistics provider according to the embodiment of the present invention;

FIG. 5 is newly added supply information according to the embodiment of the present invention;

FIG. 6 is a relative weight value of the material supplier according to the embodiment of the present invention; and

FIG. 7 is a relative weight value after the material supplier has been adjusted according to the embodiment of the present invention.

### DETAILED DESCRIPTION OF THE INVENTION

The method and system provided by the present invention are a supply chain system established with central factories, suppliers, and logistics providers as the center. Therefore, the relationship and operation of the supply chain system are described briefly, that is, the relationships among and operation of the central factories, suppliers, and logistics providers are described briefly with reference to symbols.

The central factory receives the information of the orders provided by a customer, and then obtains necessary supply information RFx through a control factor C, e.g., supply quantity, delivery date, transportation quantity according to the information of the customer's orders, and then negotiates with a supplier and a logistics provider to offer a quotation Q (e.g., cost price, supply quantity, delivery date, transportation time, and transportation quantity provided by the supplier or the logistics provider) corresponding to the supply information.

Therefore, as can be known from the above, RFx includes the provider R (e.g., a supplier, a retailer, a logistics provider, or another supplier), the quotation Q, (e.g., a supplied quantity, a cost price, a delivery date, or another quotation information), and the weight W (e.g., the weight value corresponding to the supplier or the logistics provider). Each control factor C has a corresponding RFx collection, and the whole collection of all control factors is called a supply information collection CM.

Subsequently, more than one supply chain planning information S about the central factories, the supplier, and the logistics provider are searched in all RFxs of all CMs through the planning engine based on a target condition TC, e.g., maximum profit, lowest cost, maximum transportation quantity, lowest transportation cost, or other relevant target conditions.

However, since more than one supply chain planning information are searched in the present invention, in order to clearly reveal the information indicated in the supply chain planning information, each symbol is marked, such as the supply information collection CMᵢ, the supply information RFx_{ij,k}, the control factor Cᵢⱼ, the supplier R_{ij,k}, the quotation Q_{ij,k}, and the weight W_{ij,k}. The information indicated by the marks will be illustrated below.

i: number of times to perform the supply chain planning information, i=1, . . . , n

j: control factor in the supply chain, j=1, . . . , n

k: number of the supplier or the logistics provider providing the relevant information, k=1, . . . , n

Sᵢ: supply chain planning information obtained at an i^{th} time;

CMᵢ: supply information collection at an i^{th} time;

Cᵢⱼ: control factor j at an i^{th} time;

RFx_{ij,k}: in the control factor j at an i^{th} time, supply information provided by the supplier k or the logistics provider k;

TCᵢ: target condition of the planning engine at an i^{th} time.

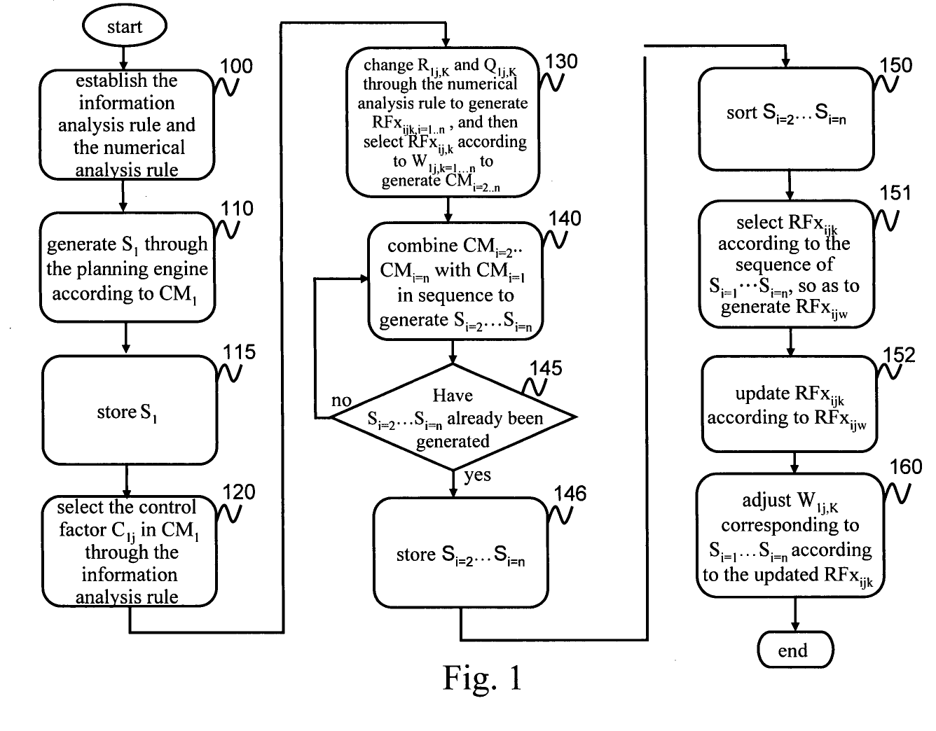

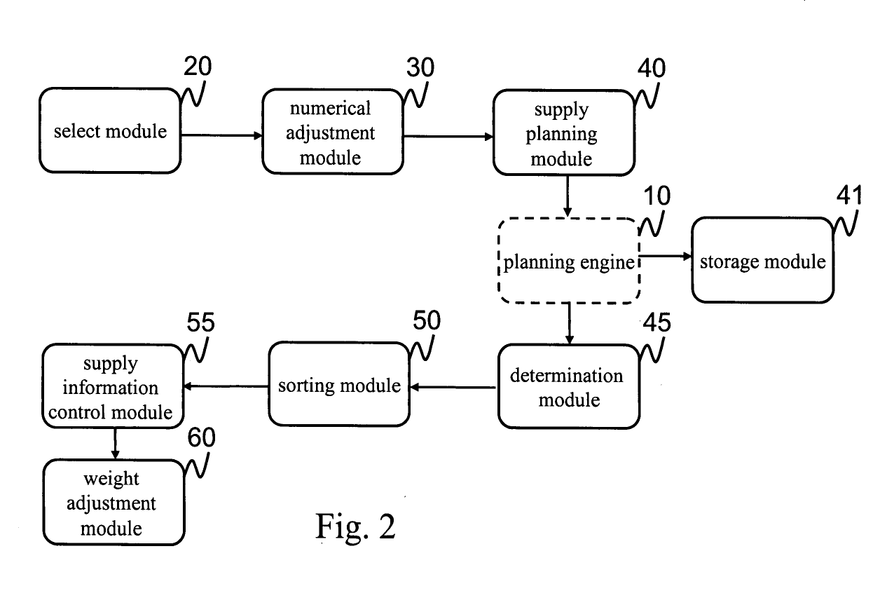

Referring to FIGS. 1 and 2, an information analysis rule and numerical analysis rule are established in the select module 20 and the numerical adjustment module 30 respectively (Step 100). The information analysis rule may include a profit analysis rule, cost analysis rule, transportation and delivery analysis rule, transportation cost rule, or the like. The numerical analysis rule may include a random number analysis rule, weight analysis rule, study analysis rule, and so on.

The planning engine 10 generates the first supply chain planning information S₁ based on the initially set TC₁, e.g., the maximum profit, the lowest cost, the maximum transportation quantity, the lowest transportation cost, or other relevant target conditions, according to the supply information collection, i.e., CM₁, provided by the supplier and the logistics provider (Step 110), and stores S₁ into a storage module 41 (Step 115).

CM₁, has the control factor C₁ⱼ (e.g., the supply quantity, the delivery date, and the transportation quantity). The control factor C₁ⱼ has at least one supply information RFx_{1j,k}. Moreover, RFx_{1j,k} at least comprises the provider R_{1j,k}, (e.g., the supplier or the logistics), the quotation Q_{1j,k} (e.g., the quantity, the price, or the delivery date), and the weight W_{1j,k} (e.g., the weight value corresponding to the supplier or the logistics provider).

Each above-mentioned supply information RFx_{1j,k} is stored in the data base (not shown) of the supply chain system, and the weight W_{1j,k} of each supply information RFx_{1j,k} is initially offered by the supply chain system.

Next, the select module 20 selects at least one control factor C₁ⱼ from CM₁ according to the information analysis rule (Step 120), and then the numerical adjustment module 30 changes the provider R_{1j,k} and the quotation Q_{1j,k} of the supply information RFx_{1j,k} in the control factor C₁ⱼ according to the numerical analysis rules, thereby generating several supply information so as to generate several supply information collections, i.e., generating RFx_{ij,k,i=2} . . . RFx_{ij,k,i=n}. Then, all or some among all RFx_{1j,k} are selected according to W_{1j,k} to generate CMᵢ₌₂ . . . CMᵢ₌ₙ (Step 130).

Then, the supply planning module 40 combines CMᵢ₌₂ . . . CMᵢ₌ₙ with the original CM₁ in sequence and generates several corresponding supply chain planning information, i.e., Sᵢ₌₂ . . . Sᵢ₌ₙ, through the planning engine 10 (Step 140). Next, a determination module 45 determines whether or not the planning engine 10 has finished generating all of the supply chain planning information (Step 145). If the determination module 45 determines that the planning engine has already generated all the corresponding Sᵢ₌₂ . . . Sᵢ₌ₙ according to CMᵢ₌₂ . . . CMᵢ₌ₙ (Step 146), the obtained Sᵢ₌₂ . . . Sᵢ₌ₙ are all stored in the storage module 41.

Then, the sorting module 50 sorts Sᵢ₌₂ . . . Sᵢ₌ₙ in the storage module 41 based on the initial target condition TC₁ (Step 150). The supply information control module 55 selects at least one of RFx_{ij,k,i=2} . . . RFx_{ij,k,i=n} corresponding to Sᵢ₌₂ . . . Sᵢ₌ₙ according to the sequence of Sᵢ₌₂ . . . Sᵢ₌ₙ, so as to generate new supply information (RFx_{ij,w}) (Step 151), and then RFx_{ij,k} is updated according to RFx_{ij,w} (Step 152). In the Step 151, at least one of RF_{ij,k,i=2} . . . RFx_{ij,k,i=n} corresponding to Sᵢ₌₁ . . . Si₌ₙ is selected through a selected value, wherein the selected value is the number of the RFx_{ij,k,i=2} . . . RF_{xij,k,i=n} needed to be selected. RFx_{ij,k,i=2} . . . RFx_{ij,k,i=n} are selected by way of: based on Sᵢ with the highest priority in the sorted Sᵢ₌₁ . . . Sᵢ₌ₙ, selecting the corresponding Sᵢ behind the selected value.

That is, the supply information control module 55 selects at least one of RFx_{ij,k,i=2} . . . RFx_{ij,k,i=n} to interact with the supplier, so as to generate a new RFx_{ij,w}. Then, RFx_{ij,k,i=2} is updated according to RFx_{ij,w}. The weight adjustment module 60 adjusts the corresponding weight W_{ij,k=1 . . . n} of R_{ij,k=1} . . . R_{ij,k=n} corresponding to each of Sᵢ₌₁ . . . Sᵢ₌ₙ according to the updated RFx_{ij,k} (Step 160).

W_{ij,k=1 . . . n} represents the weight when the method for generating supply chain planning information has been performed many times. When the method provided by the present invention will be repeatedly performed or the supply chain planning information will be re-generated in the system, the updated RFx_{ij,k} and W_{1j,k=1 . . . n} are set as CMᵢ₌₁ used for performing the next supply chain planning information.

In other words, according to the negotiation result with the supplier or the logistics provider, the central factory adjusts the weight value for the supplier or the logistics provider corresponding to the control factor of RFx in Sᵢ₌₁ . . . Sᵢ₌ₙ, which will act as a reference for the numerical adjustment module 30 in subsequent planning.

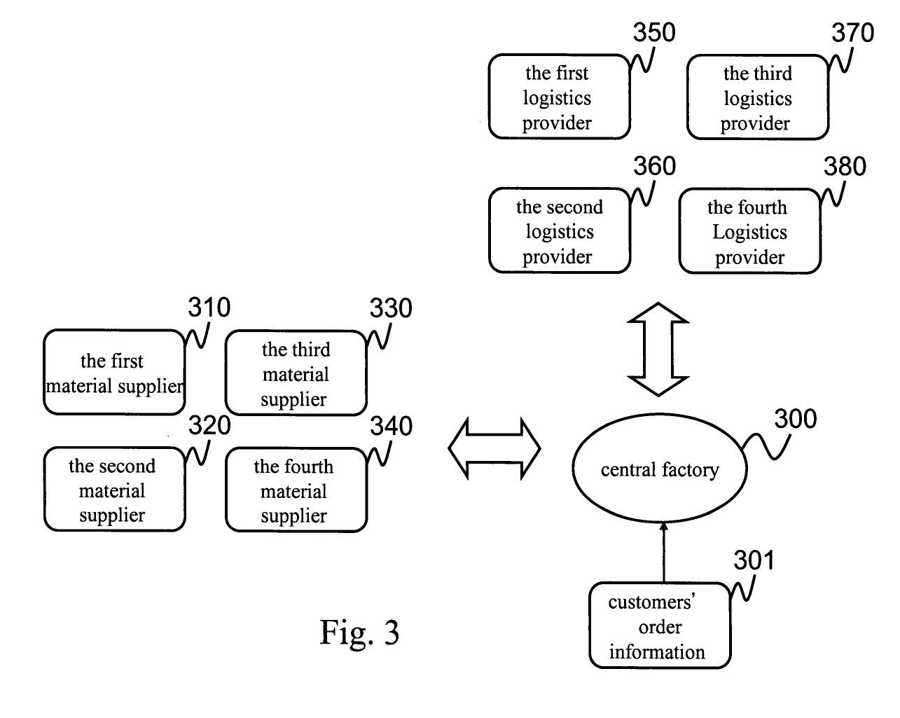

Referring to FIG. 3, it shows a supply chain consisted of a central factory 300, four material suppliers 310, 320, 330, and 340, and four logistics providers 350, 360, 370, and 380. In this embodiment, according to the requirements and demanding of the central factory 300, the suppliers 310, 320, 330, and 340, and the logistics providers 350, 360, 370, and 380, the planning mode is established considering maximum profit, so as to obtain supply chain planning information in multiple alternative schemes.

Firstly, based on the order information 301 provided by a customer, e.g., the cost price of the material, the required quantity, the delivery date of the material, or other relevant information; and the forecasting of the demanding situation for the future market, the central factory 300 negotiates with the four material suppliers 310, 320, 330, and 340 about the material supply quantity (C₁₁) and the material delivery date (C₁₂). The four material suppliers 310, 320, 330, and 340 provide the corresponding material supply quantity and the material delivery date according to their own production capacity and production scheduling.

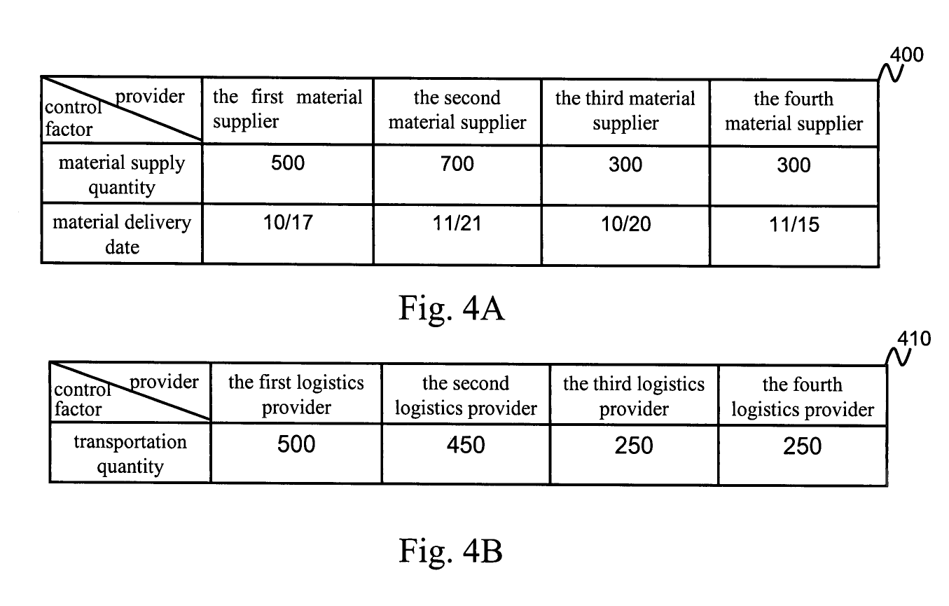

Referring to FIG. 4A, it is the supply information 400 provided by the material suppliers. The material quantity (Q_{11,1}) provided by the first material supplier 310 is 500 (RFx_{11,1}), and the delivery date (Q_{12,1}) is October 17^{th} (RFx_{12,1}). The material quantity (Q_{11,2}) provided by the second material supplier 320 is 700 (RFx_{11,2}), and the delivery date (Q_{12,2}) is November 21^{st} (RFx_{12,2}). The material quantity (Q_{11,3}) provided by the third material supplier 330 is 300 (RFx_{11,3}), and the delivery date (Q_{12,3}) is October 20^{th} (RFx_{12,3}). The material quantity (Q_{11,4}) provided by the fourth material supplier 340 is 300 (RFx_{11,4}), and the delivery date (Q_{12,4}) is November 15^{th} (RFx_{12,4}).

Then, the central factory 300 requests the four logistics providers 310, 320, 330, and 340 to provide the corresponding material transportation information (C₁₃), such as transportation time and transportation quantity, according to the material supply quantity (Q_{11k=1 . . . 4}) and the material delivery date (Q_{12k=1 . . . 4}) of each material supplier 310, 320, 330, and 340.

Referring to FIG. 4B, it is the supply information 410 provided by the logistics providers. The transportation quantity (Q_{13,1}) of the first logistics provider 350 is 500 (RFx_{13,1}). The transportation quantity (Q_{13,2}) of the second logistics provider 360 is 450 (RFx_{13,2}). The transportation quantity (Q_{13,3}) of the third logistics provider 370 is 250 (RFx_{13,3}). The transportation quantity (Q_{13,4}) of the fourth logistics provider 380 is 250 (RFx_{13,4}).

After all of the material suppliers 310, 320, 330, and 340 and the logistics providers 350, 360, 370, and 380 have provided the corresponding supply information (RFx_{1jk=1 . . . 4}, i.e., CM₁), the central factory 300 considers the material cost, freight, carrying cost, delay cost, or the like, and the interrelationship with the material suppliers 310, 320, 330, and 340 and the logistics providers 350, 360, 370, and 380, to gain the first supply chain planning information (S₁) with maximum profit as a target condition (TC₁) through calculating with a mathematical operation engine, i.e., the planning engine 10.

Then, the select module 20 analyzes and verifies the supply chain system according to the information analysis rule, which is the maximum profit analysis rule in this embodiment, so as to select the first-time control factor (C₁ⱼ) that most significantly affects the profits of the whole supply chain system. The select module 20 also selects one or more control factors (C₁ⱼ) from the material supply quantity (C₁₁), the material transportation quantity (C₁₂), and the material delivery date (C₁₃).

After the analysis and verification through the information analysis rule with maximum profit as the target condition, without changing the material transportation quantity (C₁₂), the material supply quantity (C₁₁) and the material delivery date (C₁₃) are adjusted to obtain the supply chain planning information with the target condition of maximum profit.

The numerical adjustment module 30 adjusts R_{11,k=1 . . . 4}, Q_{11,k=1 . . . 4}, R_{13,k=1 . . . 4}, and Q_{13,k=1 . . . 4} of RFx_{11,k=1 . . . 4} and RFx_{13,k=1 . . . 4} in the first supply chain planning information through the numerical analysis rule, i.e., the profit analysis rule in this embodiment, with maximum profit as the target condition (TC₁), , so as to generate more RFxs.

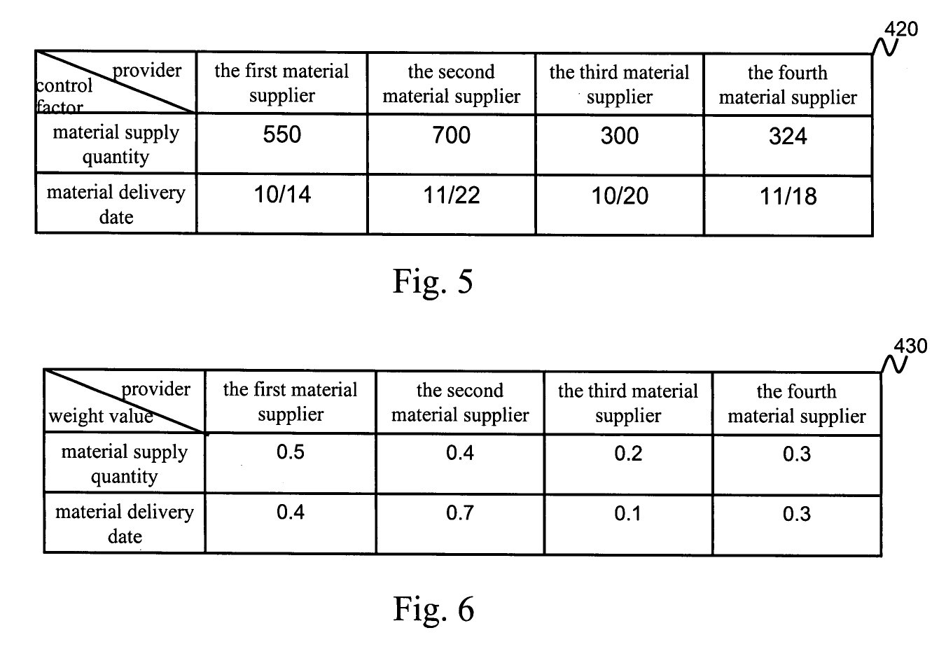

Referring to FIG. 5, it is the newly-added supply information 420 in this embodiment. Based on the material supply quantity (C₁₁) and the relative weight value (W₁₁ₖ) initially provided by the supply chain system, the material supply quantity (Q_{11,1} and Q_{11,4}) of the first material supplier 310 (R_{11,1}) and the fourth material supplier 340 (R_{11,4}) are adjusted according to the random number analysis rule: the material supply quantity (Q_{11,1}) provided by the first material supplier 310 is adjusted from 500 to 550, so as to generate the supply information RFx_{21,1}, and the material supply quantity (Q_{11,4}) provided by the fourth material supplier 340 is adjusted from 300 to 324, so as to generate the supply information RFx_{31,4}.

Furthermore, based on the material delivery date (C₁₃), the material delivery dates (Q_{13,1}, Q_{13,2} and Q_{13,4}) of the first material supplier 310 (R_{13,1}), the second material supplier 320 (R_{13,2}), and the fourth material supplier (R_{13,4}) are adjusted according to the random number analysis rule: the material delivery date (Q_{13,1}) of the first material supplier 310 is adjusted forward from October 17^{th} to October 14^{th}, so as to generate the supply information RFx_{43,1}; the material delivery date (Q_{13,2}) of the second material supplier 320 is adjusted from November 21^{st} to October 22^{nd}, so as to generate the supply information RFx_{53.2}; and the material delivery date (Q_{13,4}) of the fourth material supplier 340 is adjusted from November 15^{th} to October 18^{th}, so as to generate the supply information RFx_{63.4}.

Briefly, RFx_{21,1}, RFx_{31,4}, RF_{43,1}, RFx_{53,2}, and RFx_{63,4} are newly added after the RFx_{1j,k=1 . . . 4} provided by the material suppliers 310, 320, 330, and 340 and the logistics providers 350, 360, 370, and 380 have been adjusted through the information analysis rule and the numerical analysis rule.

Next, the supply planning module 40 combines RFx_{21,1}, RFx_{31,4}, RFx_{43,1}, RFx_{53,2}, and RF_{63,4} with the original RFx_{1j,k=1 . . . 4} one by one. That is, RFx_{i1,1}, RFx_{i1,4}, RFx_{i3,1}, RFx_{i3,2}, and RFx_{i3,4} are combined with CM₁, in sequence, so as to generate the information CM₂ . . . CM₆. Subsequently, the information CM₂ . . . CM₆ are sequentially processed by the planning engine 10 to gain S₂, S₃, S₄, S₅, and S₆6, wherein the above-mentioned S₁, S₂, S₃, S₄, S₅, and S₆ are all stored in a storage module 41.

Then, the sorting module 50 sorts the supply chain planning information of S₁, S₂, S₃, S₄, S₅, and S₆ with the maximum profit as the target condition (TC₁), and obtains the main control factor that affects the whole supply chain according to the sorting results of S₁, S₂, S₃, S₄, S₅, and S₆.

Then, the supply information control module 55 recommends one or more of the sorted S₁, S₂, S₃, S₄, S₅, and S₆ with higher priority to the decision maker based on a selected value, such that the decision maker will negotiate with the four suppliers 310, 320, 330, and 340 according to RFx_{ij,k} in the supply information collection (CMᵢ) of the selected supply chain planning information (Sᵢ), so as to generate new supply information (RFx_{ij,w}), and update the original RFx_{ij,k} according to RFx_{ij,w}.

Additionally, in different stages of the supply chain, it is an important task to select and evaluate the cooperative manufacturers, i.e., the above material suppliers 350, 360, 370, and 380 or the logistics providers 350, 360, 370, and 380, so the material suppliers 350, 360, 370, and 380 and the logistics providers 350, 360, 370, and 380 in the present invention have different weight values under different control factors. Therefore, the weight adjustment module 60 adjusts the corresponding weights (W_{1j,k=1 . . . n}) of R_{ij,k,k=1} . . . R_{ij,k,k=n} corresponding to each Sᵢ₌₁ . . . Sᵢ₌ₙ according to the updated RF_{xij,k}.

For example, if the sequence appears as S₄, S₂, S₃, S₁, S₅, and S₆ after the sorting process, W_{13,1} of the first material supplier corresponding to C₄₃ in RFx_{43,1} corresponding to S₄ will be adjusted, and the weight values of S₂, S₃, S₁, S₅, and S₆ will also be adjusted in the same way.

Furthermore, the weight adjustment module 60 also adjusts the weight values of the corresponding suppliers or logistics providers according to the response fed back by the material suppliers 310, 320, 330, and 340 or the logistics providers 350, 360, 370, and 380 about the newly-added RFx_{21,1}, RFx_{31,4}, RFx_{43,1}, RFx_{53,2}, and RFx_{63,4,} which will act as a reference for the numerical adjustment module 30 in subsequent planning, i.e., selecting the next cooperative central factory 300.

Referring to FIG. 6, it is a weight table 430 of the material suppliers. The weight values (W_{11,k=1 . . . 4}) corresponding to the material supply quantity (C_{11,k=1 . . . 4}) of the first, second, third, and fourth material suppliers 310, 320, 330, and 340 are 0.5, 0.4, 0.2, and 0.3 respectively; and the weight values (W_{13,k=1 . . . 4}) corresponding to the material delivery dates are 0.4, 0.6, 0.1, and 0.3 respectively.

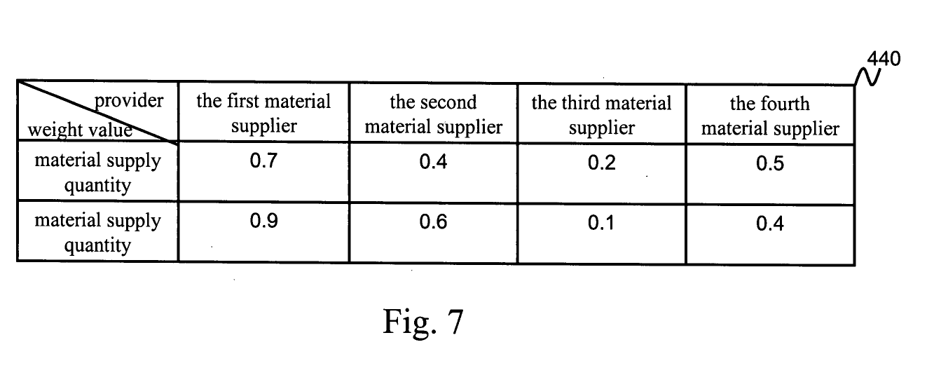

Provided that the first material supplier 310 and the fourth material supplier 340 can adjust the material supply quantity in cooperation with RFx_{21,1} and RFx_{31,4}, the supply chain system increases the weight values (W_{11,1} and W_{11,4}) for the material supply quantity of the first material supplier 310 and the fourth material supplier 340. That is, as shown in FIG. 7, which is the weight table 440 after being adjusted, the weight value (W_{11,1}) for the material supply quantity of the first material supplier 310 is adjusted from 0.5 to 0.7; and the weight value (W_{11,4}) for the material supply quantity of the fourth material supplier 340 is adjusted from 0.3 to 0.5.

Similarly, provided that the first material supplier 310 and the fourth material supplier 340 can still cooperate with RFx_{43,1} and RFx_{63,4}, whereas the second material supplier 320 cannot cooperate with RFx_{53,4}, the supply chain system increases the weight values (W_{12,1} and W_{12,4}) for the material supply quantity of the first material supplier 310 and the fourth material supplier 340. That is, as shown in FIG. 7, the weight value (W_{12,1}) for the first material supplier 310 is adjusted from 0.4 to 0.9; the weight value (W_{12,4}) for the fourth material supplier 340 is adjusted from 0.3 to 0.4; and the weight value (W_{12,2}) of the second material supplier 320 is adjusted from 0.7 to 0.6.

The above-mentioned central factory 300, the four material suppliers 310, 320, 330, and 340, and the four logistics providers 350, 360, 370, and 380 are constructed over the Internet, and they receive customers' order information and the information provided by suppliers, logistics providers, and so on through the public network (e.g., the Internet or Virtual Private Network), or a private network (e.g., wire network or wireless network).

As above-mentioned, the optimal supply chain planning information is achieved by adding restrictive conditions to the optimal supply chain planning information or re-correcting obtained optimal supply chain planning information. However, the method and system for generating supply chain planning information provided by the present invention are not used to generate optimal supply chain planning information, but rather to provide more than one supply chain planning information. The present invention mainly provides information rules to analyze and adjust the original supply information, and thereby adds various supply information different from the original one, and combines the original supply information with the newly-added one, so as to generate more than one supply chain planning information. Then, more than one supply chain planning information are provided to a decision maker for being selected to seek an improved direction to negotiate with a supplier, so as to reduce the overall cost and meanwhile meet customers' service quality requirements.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for generating supply chain planning information, wherein target condition (TCᵢ₌₁) set initially and supply information collection (CMᵢ₌₁) obtained outside are used to generate the first supply chain planning information (Sᵢ₌₁) through a planning engine; CMᵢ₌₁ includes at least one control factor (C₁ⱼ), and C₁ⱼ further includes at least one supply information (RFx_{1j,k}) containing a provider (R_{1j,k}), a quotation (Q_{1j,k}), and a weight (W_{1j,k}), the method comprising:
establishing an information analysis rule and a numerical analysis rule;
selecting at least one C₁ⱼ from CMᵢ₌₁ according to the information analysis rule;
changing R_{1j,k} and Q_{1j,k} of RFx_{1j,k} in C₁ⱼ into RFx_{ij,k,i=2} . . . RFx_{ij,k,i=n} according to the numerical analysis rule, and selecting RFx_{ij,k} to generate CMᵢ₌₂ . . . CMᵢ₌ₙ according to W_{1j,k=1 . . . n};
combining CMᵢ₌₂ . . . CMᵢ₌ₙ with CMᵢ₌₁ in sequence, and generating the corresponding Sᵢ₌₂ . . . Sᵢ₌ₙ according to the planning engine;
sorting Sᵢ₌₁ . . . Sᵢ₌ₙ based on TCᵢ₌₁;
selecting at least one of RFx_{ij,k,i=2} . . . RFx_{ij,k,i=n} corresponding to Sᵢ₌₁ . . . Sᵢ₌ₙ according to the sequence of Sᵢ₌₁ . . . Sᵢ₌ₙ, so as to generate new supply information (RFx_{ij,w});
updating RFx_{ij,k} based on RFx_{ij,w}; and
adjusting the corresponding W_{1j,k=1 . . . n} of R_{ij,k,k=1} . . . R_{ij,k,k=n} corresponding to each of Sᵢ₌₁ . . . Sᵢ₌ₙ according to the updated RFx_{ij,k}.

2. The method for generating supply chain planning information as claimed in claim 1, wherein C₁ⱼ includes a supply quantity, a delivery date, or a transportation quantity.

3. The method for generating supply chain planning information as claimed in claim 1, wherein TCᵢ₌₁ includes a maximum profit, a lowest cost, a maximum transportation quantity, or a lowest transportation cost.

4. The method for generating supply chain planning information as claimed in claim 1, wherein R_{1j,k} includes a supplier, a logistics provider, or a retailer.

5. The method for generating supply chain planning information as claimed in claim 1, wherein Q_{1j,k} includes a quantity, a price, or a delivery date.

6. The method for generating supply chain planning information as claimed in claim 1, wherein when the method for generating supply chain planning information is repeatedly performed, the updated RFx_{ij,k} and W_{1j,k=1 . . . n} are set as CMᵢ₌₁ used for subsequent execution of the method for generating supply chain planning information.

7. The method for generating supply chain planning information as claimed in claim 1, wherein the information analysis rule includes a profit analysis rule, a cost analysis rule, a transportation quantity analysis rule, or a transportation cost rule.

8. The method for generating supply chain planning information as claimed in claim 1, wherein the numerical analysis rule includes a random number analysis rule, a weight analysis rule, or a study analysis rule.

9. The method for generating supply chain planning information as claimed in claim 1, wherein the step of generating Sᵢ₌₂ . . . Sᵢ₌ₙ through the planning engine includes the step of determining whether the planning engine has generated all of Sᵢ₌₂ . . . Sᵢ₌ₙor not.

10. The method for generating supply chain planning information as claimed in claim 1, wherein in the step of generating RFx_{ij,w}, at least one of RFx_{ij,k,i=2} . . . RFx_{ij,k,i=n} corresponding to Sᵢ₌₁ . . . Sᵢ₌ₙ is selected according to a selected value that is the number of the selected RFx_{ij,k,i=2} . . . RFx_{ij,k,i=n}.

11. A system for generating supply chain planning information, wherein target condition (TCᵢ₌₁) set initially and supply information collection (CMᵢ₌₁) obtained outside are used to generate the first supply chain planning information (Sᵢ₌₁) through a planning engine; CMᵢ₌₁ includes at least one control factor (C₁ⱼ), and C₁ⱼ further includes at least one supply information (RFx_{1j,k}) containing a provider (R_{1j,k}), a quotation (Q_{1j,k}), and a weight (W_{1j,k}), and the system further enables the planning engine to generate more than one Sᵢ₌₂ . . . Sᵢ₌ₙ by dynamically adjusting C₁ⱼ and RFx_{1j,k}, the system comprising:
a select module used to store an information analysis rule and to select at least one C₁ⱼ from CMᵢ₌₁ according to the information analysis rule;
a numerical adjustment module used to store a numerical analysis rule, to change R_{1j,k} and Q_{1j,k} of RFx_{1j,k} in C₁ⱼ into RFx_{ij,k,i=2} . . . RFx_{ij,k,i=n} according to the numerical analysis rule, and to select RFx_{ij,k} according to W_{1j,k=1 . . . n}, so as to generate CMᵢ₌₂ . . . CMᵢ₌ₙ;
a supply planning module used to combine CMᵢ₌₂ . . . CMᵢ₌ₙ with CMᵢ₌₁ in sequence and to generate the corresponding Sᵢ₌₂ . . . Sᵢ₌ₙ through the planning engine;
a sorting module used to sort Sᵢ₌₁ . . . Sᵢ₌ₙ based on TCᵢ₌₁;
a supply information control module used to select at least one RFx_{ij,k,i=2} . . . RFx_{ij,k,i=n} corresponding to Sᵢ₌₁ . . . Sᵢ₌ₙ according to the sequence of Sᵢ₌₁ . . . Sᵢ₌ₙ, so as to generate new supply information (RFx_{ij,w}), and to update RFx_{ij,k} based on RFx_{ij,w}; and
a weight adjustment module used to adjust the corresponding W_{1j,k=1 . . . n} in R_{ij,k,k=1} . . . R_{ij,k,k=n} corresponding to Sᵢ₌₁ . . . Sᵢ₌ₙ according to the updated RFx_{ij,k}.

12. The system for generating supply chain planning information as claimed in claim 11, wherein C₁ⱼ includes a supply quantity, a delivery date, or a transportation quantity.

13. The system for generating supply chain planning information as claimed in claim 11, wherein TCᵢ₌₁ includes a maximum profit, a lowest cost, a maximum transportation quantity, or a lowest transportation cost.

14. The system for generating supply chain planning information as claimed in claim 11, wherein R_{1j,k} includes a supplier, a logistics provider, or a retailer.

15. The system for generating supply chain planning information as claimed in claim 11, wherein Q_{1j,k} includes a quantity, a price, or a delivery date.

16. The system for generating supply chain planning information as claimed in claim 11, wherein W_{1j,k} is a weight value.

17. The system for generating supply chain planning information as claimed in claim 11, wherein the information analysis rule includes a profit analysis rule, a cost analysis rule, a transportation quantity analysis rule, or a transportation cost rule.

18. The system for generating supply chain planning information as claimed in claim 11, wherein the numerical analysis rule includes a random number analysis rule, a weight analysis rule, or a study analysis rule.

19. The system for generating supply chain planning information as claimed in claim 11, further comprising a determination module for determining whether the planning engine has generated all of Sᵢ₌₂ . . . Sᵢ₌ₙ or not.

20. The system for generating supply chain planning information as claimed in claim 11, wherein in the step of generating RFx_{ij,w}, at least one of RFx_{ij,k,i=2} . . . RFx_{ij,k,i=n} corresponding to Sᵢ₌₁ . . . Sᵢ₌ₙ is selected through a selected value that is the number of the selected RFx_{ij,k,i=2} . . . RFx_{ij,k,i=n}.
